(19) United States
(12) Patent Application Publication
(10) Pub. No.: US 2026/0254322 A1
(43) Pub. Date: Aug. 27, 2026

(54) STATOR OF AN AXIAL-FLOW ROTARY ELECTRICAL MACHINE

(71) Applicants: AMPERE S.A.S, Boulogne-Billancourt (FR); WHYLOT, Cambes (FR)

(72) Inventor: Jere KOLEHMAINEN, Cleon (FR)

(73) Assignees: AMPERE S.A.S, Boulogne-Billancourt (FR); WHYLOT, Cambes (FR)

(21) Appl. No.: 18/879,083

(22) PCT Filed: Jun. 27, 2023
(86) PCT No.: PCT/FR2023/050970

§ 371 Date: Dec. 26, 2024

(30) Foreign Application Priority Data
Jun. 27, 2022 (FR) 2206403

(51) Int. Cl. H02K 9/197; H02K 1/14

(52) U.S. Cl. CPC H02K 9/197; H02K 1/146

(57) ABSTRACT

A stator of an axial-flow rotary electrical machine and a production method. The stator has: a support ring having N teeth each extending as an axial component as far as a top, said N teeth being separated respectively from one another by N housings; N conductive-wire windings respectively wound around said N teeth; N pairs of wings respectively secured to the tops of the N teeth, the two wings of each of said N pairs extending laterally opposite each other and respectively in line with each of the N windings. The N pairs of wings are at least partially embedded together in a single piece forming a cover and fitting on top of the N teeth, so as to confine said N housings so as to be able to refrigerate the N housings.

The present invention relates to a stator of an axial-flow rotary electrical machine. One field of application envisaged is in particular, but not exclusively, that of driving motor vehicles, in particular electrical or hybrid vehicles.

Known axial-flow rotary electrical machines usually comprise a stator and, facing it, a discoidal rotor equipped with permanent magnets.

Some other electrical machines comprise a rotor located between two stators.

The stators of these electrical machines include a support ring, or yoke, produced from a magnetic material, said ring having a plurality of teeth, fifteen for example, extending along an axial component. The support rings are produced from a stack of uniform so-called “electrical” sheets. These uniform sheets obtained by simultaneous punching and rolling of one and the same “electrical” steel strip.

The teeth are regularly spaced apart from one another, defining free housings between them. The housings have a roughly right-angled parallelepipedal shape, while the teeth are roughly prismatic in shape. The teeth thus extend in a point in a radial component, towards the centre of the ring.

Thus the teeth each comprise a conductive-wire winding forming a winding extending in the free housings.

In addition, the ring has, at the top of each of the teeth, two wings opposite to each other with respect to the tooth, to extend in line with the windings. These two opposite wings are produced from a magnetic material also so as to be able to best guide the field lines outside the conductive-wire windings.

Reference may be made to the document FR 2 998 112 A 1, which describes such a stator.

These stators make it possible to produce efficient electrical machines. However, their conductive-wire windings generate a great deal of thermal energy, which impairs the performances of the machine.

Thus a problem that arises and which the present invention aims to solve is to provide a stator that is not only easy and inexpensive to manufacture but also which has better efficiency.

For the purpose of solving this problem, and according to a first object, a stator of an axial-flow rotary electrical machine is proposed comprising: a support ring produced from a magnetic material, said support ring having N teeth each extending as an axial component as far as a top, N being an integer greater than 2, said N teeth being separated respectively from one another by N housings so that each of said teeth extends between two adjacent housings; N conductive-wire windings respectively wound around said N teeth, each of said N windings extending in said two adjacent housings; and N pairs of wings made from magnetic material respectively secured to the tops of said N teeth, the two wings of each of said N pairs extending laterally opposite each other with respect to each of said N teeth and respectively in line with each of said N windings.

Thus said N pairs of wings are at least partially embedded together in a single piece forming a cover and fitting on top of said N teeth, so as to confine said N housings so as better to be able to refrigerate them.

Thus one feature of the invention lies in the use of a piece adapted to form a cover, and including the N pairs of wings, to confine the housings so as to refrigerate them effectively. This is because the thermal energy released by Joule effect in the wires of the windings can be effectively discharged by means of a refrigerant, provided that the housings in which these windings extend are confined.

By discharging this thermal energy, the efficiency and the performances of the electrical machine are appreciably improved.

On the other hand, the air gap, i.e. the spacing between the elements of the stator and those of the rotor must be minimal to preserve good performance of the machine.

By means of the object of the invention, the top of the teeth and their wings remain close to the rotor despite the use of a single piece forming a cover, since they are integral parts of this cover, as will be explained in more detail later in the description.

Furthermore, and as will also be explained below, said N pairs of wings are advantageously at least partially embedded together in a polymer material.

According to a particularly advantageous embodiment of the invention, said N housings are refrigerated by injecting a refrigerating fluid. For example, a cold-gas inlet and an outlet for discharging the gas are provided for each of the housings. Thus the thermal energy released by the windings is exchanged with the cold gas, which can be discharged, once heated, via the outlet.

Preferentially, the refrigerating fluid is guided inside said N housings inside a pipe. Thus a pipe is provided that extends inside each of the housings, around the wire windings. The pipe is then connected outside the housings to a refrigerating-fluid circuit.

Thus, according to yet another embodiment, and since the housings are sufficiently fluidtight, an inlet for a refrigerating liquid and a corresponding outlet are provided. In this way it is possible for example to inject, inside the housings, oil for discharging the thermal energy produced by the conductive wires of the windings.

According to a particularly advantageous embodiment of the invention, the two wings of each of said N pairs of wings form together a single element coming to be applied against the top of each of said N teeth. In this way, the magnetic field lines generated by the wire windings through the teeth extend without discontinuity through the wings. This also contributes to the performance of the electrical machine.

According to a particularly advantageous but non-limitative variant implementation of the invention, the wings of said N pairs of wings are produced by sintering metal powder. Thus this is also the case when the two wings of each of said N pairs of wings form together a single element. Thus the wings are produced at an advantageous cost and are easy to implement in said single piece to form a cover, as will be explained in more detail in the remainder of the description.

According to another variant implementation of the invention, the wings of said N pairs of wings are produced from a composite material with metal reinforcement fibres. In this way, the metal reinforcement fibres are embedded in a matrix of a polymer material. Consequently, the single piece forming a cover includes in its thickness the wings formed by the metal fibres. Consequently, both the function of the wings as guide for the field lines as close as possible to the rotor and the function of confinement of the housings are obtained. Thus such features make it possible to obtain perfectly fluidtight housings. This facilitates the cooling of the conductive wires.

According to another object, a method for producing a stator of an axial-flow rotary electrical machine as described above is proposed. The method comprises the following steps: a support ring is provided produced from a magnetic material, said support ring having N teeth each extending as an axial component as far as a top, N being an integer greater than 2, said N teeth being separated respectively from one another by N housings so that each of said teeth extends between two adjacent housings; N conductive-wire windings are respectively wound around said N teeth so as to form N windings, each of said N windings extending in said two adjacent housings; N pairs of wings made from magnetic material are provided and said N pairs of wings are respectively secured to the tops of said N teeth, the two wings of each of said N pairs extending laterally opposite each other with respect to each of said N teeth and respectively in line with each of said N windings. And said N pairs of wings are at least partially embedded together in a single piece forming a cover and fitting on top of said N teeth, so as to confine said N housings so as better to be able to refrigerate said N housings.

According to a first embodiment, the N pairs of wings are overmoulded together in a single piece with a polymer material to produce the single piece forming the cover. The wings are then connected together by portions of walls made from relatively fine polymer material. According to this embodiment, the wings are held against the teeth between the tops, while the portions of walls of the cover are applied against the tops directly.

According to a second embodiment, the two wings of each of said N pairs of wings are formed together in a single element, and said single element is applied against the top of each of said N teeth. Thus the two wings in a single element are applied against the top of the teeth and the N single elements are overmoulded directly on the ring to form the cover. In this way the fluidtightness of the housings is improved further while ensuring perfect continuity of the field lines.

Preferentially, the wings of said N pairs of wings are produced by sintering metal powder. In this way it is easy to select and produce the appropriate material for guiding the field lines.

According to a third implementation, the wings of said N pairs of wings are produced from a composite material with metal reinforcement fibres. In this way, the single piece forming a cover is relatively homogeneous and has regions forming the wings, themselves consisting of one and the same continuous element. There also, the piece forming a cover is directly overmoulded on the ring, as will be explained in more detail in the remainder of the description.

Other features and advantages of the invention will become apparent upon reading the description made hereinafter of particular embodiments of the invention, given for indication but without limitation, with reference to the appended drawings wherein:

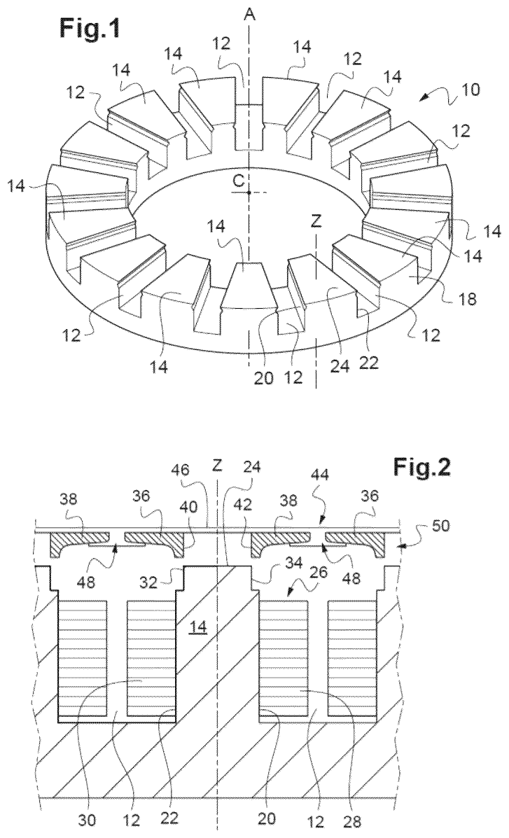

FIG. 1 is a schematic perspective top view of an element of the stator in accordance with the invention according to one embodiment;

FIG. 2 is a partial schematic view in cross section of an element of the object of FIG. 1 in combination with a first other element and according to a first embodiment;

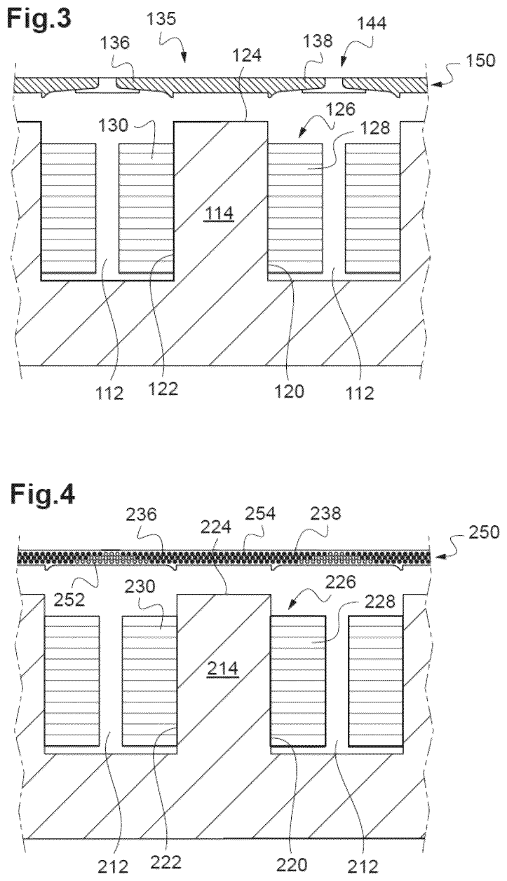

FIG. 3 is a partial schematic view in cross section of an element of the object of FIG. 1 in combination with a second other element and according to a second embodiment;

FIG. 4 is a partial schematic view in cross section of an element of the object of FIG. 1 in combination with a third other element and according to a third embodiment in a first implementation step;

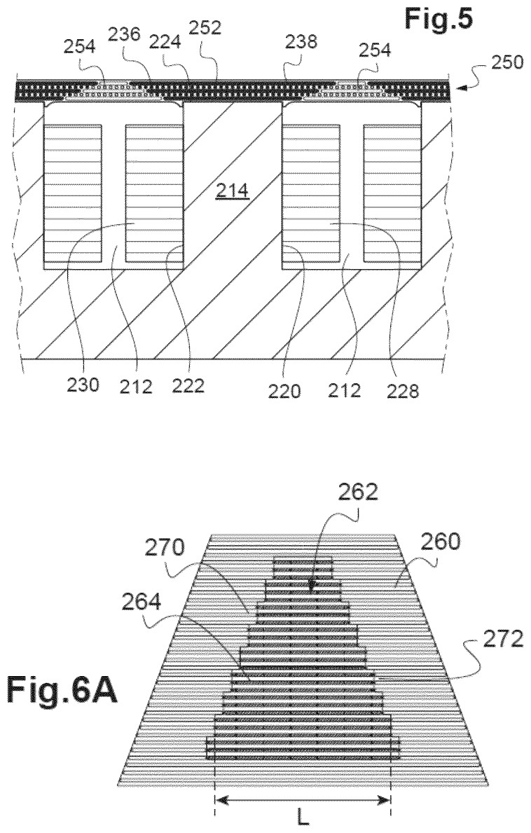

FIG. 5 is a schematic view of the object of FIG. 4 in a second implementation step;

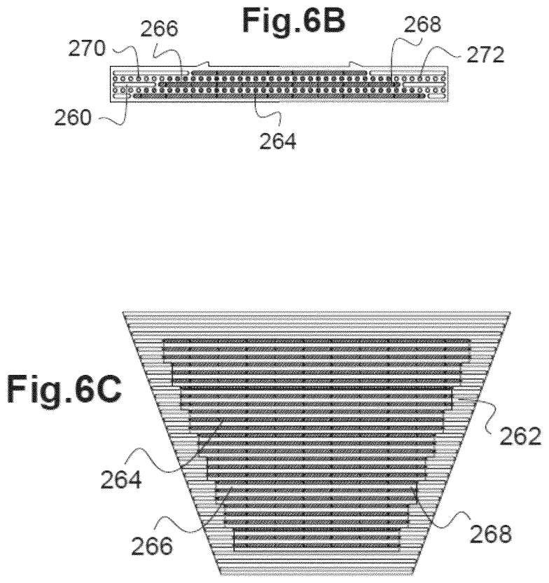

FIG. 6A-FIG. 6C are schematic views of implementation of the invention according to the third embodiment that is the object of FIG. 4 and FIG. 5;

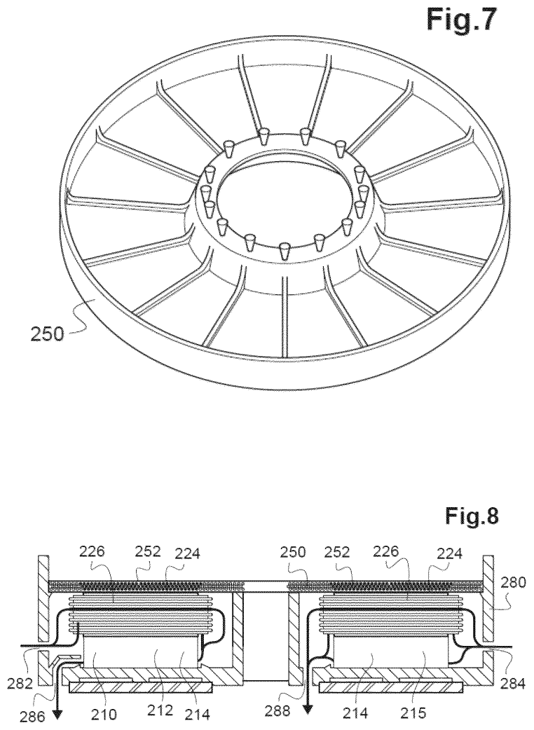

FIG. 7 is a schematic perspective view of an element of the stator obtained according to the third embodiment; and

FIG. 8 is a partial schematic view in radial section of the stator that is the object of the invention.

[FIG. 1 ] shows a support ring 10 having a centre C and a symmetry axis A. The ring 10 consists of a stack of a plurality of “electrical” steel sheets.

Thus, in the in no way limitative example presented here, the ring 10 has fifteen U-shaped grooves 12 with cylindrical symmetry and a square base and oriented on straight lines perpendicular to the symmetry axis A that they intersect. In addition, the U-shaped grooves 12 are regularly spaced apart from one another. The fifteen U-shaped grooves 12 thus define fifteen substantially prismatically-shaped teeth 14, extending along an axial component parallel to the symmetry axis A. Thus the teeth 14 extend, for example, in the axial direction, over a thickness lying between one third and one quarter of the total thickness of the ring 10.

The prismatically-shaped teeth 14 are also oriented radially in the direction of the centre C of the ring 10. Thus the length of the teeth 14 in this radial direction is for example between one third and one quarter of the external radius of the ring 10.

It will be observed that each of the teeth 14 has, inside the ring 10, an interior face 16, substantially concave, opposite to an external face 18, substantially convex and oriented towards the outside of the ring 10.

Each of the teeth 14 also has two opposite lateral faces 20, 22, defined by the two adjacent grooves 12, and a free top face 24.

Each of the fifteen teeth 14 then receives the winding of a conductive wire around an axis Z, substantially parallel to the symmetry axis A of the ring 10.

Thus, on [FIG. 2], there is a view in cross section of a tooth 14, on a plane parallel to the symmetry axis A of the ring 10, and in the vicinity of the interior face 16, also parallel to the mid-plane that it defines.

Thus, on [FIG. 2], there are the two opposite lateral faces 20, 22 and a winding 26, divided into two first half-windings 28, 30 that extend along the two opposite lateral faces 20, 22 and thus in the two adjacent grooves 12, which then form two adjacent housings.

Obviously, the winding 26 also extends facing the interior face 16 and the opposite exterior face 18.

The conductive-wire winding 26 makes it possible, by supplying the conductive wire with electric current, to generate, through the tooth 14, a magnetic field parallel to the axis Z. It will be observed that the magnetic field lines tend to move away from the axis Z, outside the winding 26.

Thus it is opportune that these field lines are guided inside a metal material outside the winding 26 and beyond the tooth 14.

In addition, the electric current tends to generate, by Joule effect, thermal energy inside the housings.

Thus one aim of the invention is to confine the housings formed by the grooves 12 so as to be able to effectively discharge the thermal energy that accumulates therein.

Thus, on [FIG. 2], a first embodiment is also presented, making it possible both to guide the field lines beyond the tooth 14 and also to confine the housings formed by the grooves 12.

According to this first embodiment, the two opposite lateral faces 20, 22 of each of the teeth 14 are notched at the rear of the free top face 24 so as to form two opposite recesses 32, 34.

Each of the teeth 14 is then associated with two first wings 36, 38, obtained by sintering metal powder, and each having a return 40, 42.

The two first wings 36, 38 are advantageously joined together in a single piece at the end of the teeth 14, by a portion, not shown, extending along the interior face 16, and opposite by a portion, also not shown, extending along the exterior face 18.

Thus the fifteen pairs of wings, offset regularly from one another by 30°, are overmoulded by a layer of a polymer material 44. The polymer material forms thin film portions 46 between the wings 36, 38 of one and the same pair of wings, and also lines the spaces 48 that extend between the wings 36, 38 of each of the two pairs of continuous wings, and this in a fluidtight manner. In other words, the fifteen pairs of wings 36, 38 are partially embedded in the layer of polymer material 44.

Thus all the fifteen pairs of overmoulded wings 36, 38 form a fluidtight cover 50 that can then cover the ring. The returns 40, 42 of each of the pairs of wings 36, 48 then respectively engage in the opposite recesses 32, 34, while the thin film portions 46 are applied against the top face 24 of each of the teeth 14.

By virtue of this embodiment, the air gap between the elements of the rotor and of the stator can be very thin, by virtue of the thin film portions 46. The electrical machine will then keep a good performance.

Thus the grooves 12 forming housings are confined and can easily be refrigerated, as will be explained below.

Reference will now be made to [FIG. 3] showing a second confinement mode of the housings formed by the grooves 12.

Thus the similar elements will have the same reference as those of the object of [FIG. 2] preceded by: a “1”.

Thus, on [FIG. 3], there are the two opposite lateral faces 120, 122 and the winding 126, divided into two second half-windings 128, 130 that extend along the two opposite lateral faces 120, 122 and thus in the two adjacent grooves 112, which then form two adjacent housings.

The winding 126 also extends facing the interior face and the opposite exterior face.

Thus, according to this second embodiment making it possible both to guide the field lines beyond the tooth 114 and also to confine the housings formed by the grooves 112, two second wings 136, 138 of one and the same pair of wings are formed together by a single element 135 applied against the top, or free top face 124, of each of the teeth 114.

The element 135 is also obtained by sintering metal powder.

Thus the fifteen elements 135, offset regularly from one another by 30°, are overmoulded by another layer of a polymer material 144. Thus the fifteen elements 115 defining the pairs of wings 136, 138 are embedded in the layer of the other layer of polymer material 144.

It will be observed that the element 115 made from magnetic material comes directly into contact with the free top face 124.

Thus all the fifteen elements 135 form a fluidtight cover 150 that can then cover the ring.

Reference will now be made to [FIG. 4] showing a third confinement mode of the housings formed by the grooves 12.

Thus the elements similar to those of the object of [FIG. 2] will have the same reference preceded by a: “2”.

Thus, on [FIG. 4], there are the two opposite lateral faces 220, 222 and the winding 226, divided into two third half-windings 228, 230 that extend along the two opposite lateral faces 220, 222 and thus in the two adjacent grooves 212, which then form two adjacent housings.

The winding 226 also extends facing the interior face and the opposite exterior face.

According to this third embodiment making it possible to guide the field lines beyond the tooth 214 and also to confine the housings formed by the grooves 212, the fluidtight cover 250 is formed in a single piece from a composite material including portions of a layer of metal fibre 252 and portions of a layer of glass fibre 254, the whole embedded in a matrix of a polymer material. The method for producing the composite will be explained later in the description.

Thus the portion of a layer of metal fibre 252 impregnated by its matrix defines two third wings 236, 238, of one and the same pair of wings, and they are therefore formed together. The portion of a layer of metal fibre 252 is applied against the top, or free top face 224, of each of the teeth 214.

The fifteen portions of a layer of metal fibre 252 offset regularly from one another by 30° between the fifteen portions of a layer of glass fibre 254 are impregnated by the polymer matrix and are overmoulded together directly on the ring 210, as illustrated in [FIG. 5], forming the cover 250.

A description will be given with reference to [FIG. 6A]-[FIG. 6C] of the method for obtaining the cover 250 illustrated on [FIG. 5].

Thus [FIG. 6A] illustrates, seen from below, a first stack 260 of trapezoidal portions of a layer of glass fibre having a central aperture 262, also trapezoidal. It also illustrates a second stack 264 of trapezoidal portions of a layer of metal fibre.

The two stacks 260, 264 have substantially the same thickness. For example, they each comprise five crossed fibre layers.

Thus the width L of the five layers of the second stack 264 increases, from the view from below appearing on [FIG. 6A], to the plan view appearing on [FIG. 6C]. Conversely, the five layers of the first stack 260 have a central aperture 262 that broadens in the direction of the width between the view from below appearing on [FIG. 6A] and the plan view appearing on [FIG. 6C].

Thus, as illustrated on [FIG. 6B], seen on the edge, the second stack 264 has two opposite lateral edges 266, 268 in a bevel, while the first stack 260 has two opposite interior edges 270, 272 in a bevel also, which are applied opposite against and two opposite lateral edges 266, 268. In this way, the respective superimposition of the lateral and interior edges 266, 270; 268, 272 remains with constant thickness of the five fibre layers.

Thus fifteen first and second stacks are fitted edge to edge in a ring in a mould, so that the widest layer of the second stack 264 is applied against the bottom of the mould.

The ring 10 is then adjusted in the mould, so that the free top face 224 of each of the teeth comes to be applied precisely and respectively against the narrowest layer of each of the second stacks 264.

And a polymer material is then injected into the mould, preferably a thermoplastic polymer material viscous at a temperature above 100° C. The polymer material impregnates all the layer stacks.

In this way, after the polymer cools, the cover 250 is obtained, made in a single piece that is found on [FIG. 7] in perspective, without the ring for explanatory reasons.

It will be observed that the two bevelled opposite lateral edges 266, 268 of the second stack 264, shown on [FIG. 6B], then form the two opposite wings 236, 238 as shown on [FIG. 5].

[FIG. 8] thus illustrates, in a diametral section and in accordance with a particular embodiment, the cover 250, which confines the free spaces 212. The ring 210 can be seen, installed inside a circular U-shaped receptacle 280, which cooperates with the cover 250 in a fluidtight manner.

The windings 226 can be seen around the teeth 214. The portions of a layer of metal fibre 252 impregnated with polymer can also be seen, respectively applied against the free top faces 224 of the teeth 214.

The elements of the rotor of the electrical machine will thus be able to extend facing these impregnated portions of a layer of metal fibre 252.

Thus the circular U-shaped receptacle 280 has radial entry orifices 282, 284 for refrigerating fluid, emerging in the free spaces 212. And it also has axial exit orifices 286, 288, for discharging the hot fluid. And in this way, by virtue of the fluidtight cover 250, the refrigerating fluid can circulate without leakage around the windings 226 so as to cool them.

In this way the efficiency of the electrical machine is not affected.

The cover 250 has the advantage of having magnetic portions consisting of metal fibre, which extend on the surface of the cover 250. And these magnetic portions can interact freely with the elements of the rotor. Under these conditions, the air gap is maintained, and the electrical machine keeps all its performances.

The ring 210 described above has fifteen teeth. According to certain other embodiments, it has fewer of them and, according to others, it has more of them. Obviously, the number of pairs of wings is adapted accordingly.

1. A stator of an axial-flow rotary electrical machine comprising:
a support ring produced from a magnetic material, said support ring having N teeth each extending as an axial component as far as a top, N being an integer greater than 2, said N teeth being separated respectively from one another by N housings so that each of said teeth extends between two adjacent housings;
N conductive-wire windings respectively wound around said N teeth, each of said N windings extending in said two adjacent housings;
N pairs of wings made from magnetic material respectively secured to the tops of said N teeth, the two wings of each of said N pairs extending laterally opposite each other with respect to each of said N teeth and respectively in line with each of said N windings;
wherein said N pairs of wings are at least partially embedded together in a single piece forming a cover and fitting on top of said N teeth, so as to confine said N housings so as to be able to refrigerate said N housings.

2. The stator according to claim 1, wherein said N housings are refrigerated by injecting a refrigerating fluid.

3. The stator according to claim 2, wherein said refrigerating fluid is guided inside said N housings inside a pipe.

4. The stator according to claim 1, wherein the two wings of each of said N pairs of wings form together a single element coming to be applied against the top of each of said N teeth.

5. The according to claim 1, wherein the wings of said N pairs of wings are produced by sintering metal powder.

6. The stator according to claim 1, wherein the wings of said N pairs of wings are produced from a composite material with metal reinforcement fibres.

7. A method for producing a stator of an axial-flow rotary electrical machine according to claim 1, comprising the following steps:
a support ring is provided, produced from a magnetic material, said support ring having N teeth each extending as an axial component as far as a top, N being an integer greater than 2, said N teeth being separated respectively from one another by N housings so that each of said teeth extends between two adjacent housings;
N conductive-wire windings are respectively wound around said N teeth so as to form N windings, each of said N windings extending in said two adjacent housings;
N pairs of wings are provided, made from magnetic material and said N pairs of wings are respectively secured to the tops of said N teeth, the two wings of each of said N pairs extending laterally opposite each other with respect to each of said N teeth and respectively in line with each of said N windings;
wherein said N pairs of wings are at least partially embedded together in a single piece forming a cover and said N teeth are covered, so as to confine said N housings so as to be able to refrigerate said N housings.

8. The method for producing a stator according to claim 7, wherein the two wings of each of said N pairs of wings are formed together in a single element, and said single element is applied against the top of each of said N teeth.

9. The method for producing a stator according to claim 7, wherein the wings of said N pairs of wings are produced by sintering metal powder.

10. The method for producing a stator according to claim 7, wherein the wings of said N pairs of wings are produced from a composite material with metal reinforcement fibres.
